(19) United States
(12) Patent Application Publication
(10) Pub. No.: US 2012/0016593 A1
(43) Pub. Date: Jan. 19, 2012

(54) METHOD AND APPARATUS FOR WORLDWIDE SREENING FOR HUMAN PAPILLOMA VIRUS

(75) Inventors: Frank Karlsen, Klokkarstua (NO); Hanne Skomedal, Borgen (NO)

(73) Assignee: NORCHIP A/S, Klokkarstua (NO)

(21) Appl. No.: 13/128,481

(22) PCT Filed: Nov. 12, 2009
(86) PCT No.: PCT/EP2009/008074

§ 371 Date: Sep. 23, 2011

(30) Foreign Application Priority Data
Nov. 12, 2008 (GB) 0820720.1

(51) Int. Cl. G06F 19/28

(52) U.S. Cl. 702/19

(57) ABSTRACT

The invention relates to in vitro methods of screening female human subjects for the presence of human papillo mavirus, for example as a marker of cervical epithelial precancer. In particular, the invention provides methods and apparatus which can be used to filter a patient data set of measurements related to multiple HPV types according to the geographical location of the patient under test, so that only those measurements of HPV types which are pre-determined to be relevant for the geographical region in which the patient under test is located are selected for output/display.

### FIELD OF THE INVENTION

The present invention relates to in vitro methods of screening female human subjects for the presence of human papillomavirus, for example as a marker of cervical epithelial precancer. In particular, the invention provides methods and apparatus which can be used to filter a patient data set of measurements related to multiple HPV types according to the geographical location of the patient under test, so that only those measurements of HPV types which are pre-determined to be relevant for the geographical region in which the patient under test is located are selected for output/display.

### BACKGROUND TO THE INVENTION

Cervical carcinoma is one of the most common malignant diseases world-wide and is one of the leading causes of morbidity and mortality among women (Parkin D M, Pisani P, Ferlay J (1993) Int J Cancer 54: 594-606; Pisani P, Parkin D M, Ferlay J (1993) Int J Cancer 55: 891-903). 15,700 new cases of invasive cervical cancer were predicted in the United States in 1996, and the annual world-wide incidence is estimated to be 450,000 by the World Health Organization (1990). The annual incidence rate differs in different parts of the world, ranging from 7.6 per 100,000 in western Asia to 46.8 per 100,000 in southern Africa (Parkin et al., 1993 ibid).

The current conception of cervical carcinoma is that it is a multistage disease, often developing over a period of 10-25 years. Invasive squamous-cell carcinoma of the cervix is represented by penetration through the basal lamina and invading the stroma or epithelial lamina propria. The clinical course of cervical carcinoma shows considerable variation. Prognosis has been related to clinical stage, lymph node involvement, primary tumour mass, histology type, depth of invasion and lymphatic permeation (Delgado G, et al., (1990) Gynecol Oncol 38: 352-357). Some patients with less favourable tumour characteristics have a relatively good outcome, while others suffer a fatal outcome of an initially limited disease. This shows a clear need for additional markers to further characterise newly diagnosed cervical carcinomas, in order to administer risk-adapted therapy (Ikenberg H, et al., Int. J. Cancer 59:322-6. 1994).

Almost 100 case-control studies have examined the relationship between human papillomavirus (HPV) and cervical neoplasia and almost all have found positive associations (IARC monographs, 1995). The association is strong, consistent and specific to a limited number of viral types (Muñoz N, Bosch F X (1992) HPV and cervical neoplasia: review of case-control and cohort studies. IARC Sci Publ 251-261). Among the most informative studies, strong associations with HPV 16 DNA have been observed with remarkable consistency for invasive cancer and high-grade CIN lesions, ruling out the possibility that this association can be explained by chance, bias or confounding (IARC monographs, 1995). Indirect evidence suggested that HPV DNA detected in cancer cells is a good marker for the role of HPV infection earlier in the carcinogenesis. Dose-response relationship has been reported between increasing viral load and risk of cervical carcinoma (Muñoz and Bosch, 1992 ibid).

The most frequent HPV types found in squamous-cell cervical carcinomas are HPV 16 (41%-86%) and 18 (2%-22%). In addition HPV 31, 33, 35, 39, 45, 51, 52, 54, 56, 58, 59, 61, 66 and 68 are also found (IARC, monographs, 1995). In the HPV2000 International conference in Barcelona HPV 16, 18, 31 and 45 were defined as high risk, while HPV 33, 35, 39, 51, 52, 56, 58, 59, 68 were defined as intermediate risk (Keerti V. Shah. P71). The 13 high risk plus intermediate risk HPVs are together often referred to as cancer-associated HPV types.

The geographical distribution of high-risk HPV types has been the subject of a number of studies. Clifford et al. (Clifford G M, et al. (2003) British Journal of Cancer 88:63-73) collated the relevant published data in order to identify the most prevalent HPV types associated with cervical cancer worldwide. The most common HPV types in cervical cancer were (in order of decreasing prevalence) 16, 18, 45, 31, 33, 58, 52, 35, 59, 56, 6, 51, 68, 39, 82, 73, 66 and 70. When divided into geographical regions, the two most prevalent HPV types in Africa, Asia, Europe, North America/Australia and South/Central America were 16 and 18. However, the prevalence of further HPV risk types was found to vary with region. In Africa, the next most prevalent types were (in order of decreasing prevalence) types 45, 33 and 31. In Asia, types 58, 52, 45, and 33 were the next most prevalent (in order of decreasing prevalence). Types 33 and 31 were the next most prevalent in Europe, whilst in North America/Australia the next two most prevalent types were 31 and 33 (in order of decreasing prevalence). In South/Central America, the next most prevalent types were (in order of decreasing prevalence) 31 and 45. The study concludes that, after types 16 and 18, the most important HPV risk type is 45, followed by 31, 33, 58 and 52.

Munoz et al. (Muñoz N, et al., (2004) Int. J. Cancer 111: 278-285) conducted a pooled analysis of data from an international survey of HPV types in cervical cancer and from a multi-centre case-control study. The analysis, which contained samples from 25 countries, highlighted the 15 most common HPV types associated with cervical cancer as (in order of decreasing frequency) 16, 18, 45, 31, 33, 52, 58, 35, 59, 56, 39, 51, 73, 68, and 66. HPV type 16 was universally the most common HPV type associated with cervical carcinoma, however distinct variations in the contribution of the other HPV risk types were reported. A higher than average prevalence of HPV 16 was reported in Northern Africa, of type 18 in south Asia, of type 45 in Sub-Saharan Africa and of type 31 in Central/South America. This study proposes that a vaccine to the 7 most common HPV types would prevent around 87% of cervical cancer cases worldwide. With reference to HPV screening programmes, it concludes that the impact of modifying the number of HPV types included in screening cocktails is likely to be small.

Clifford et al. (Clifford G M, et al., (2005) Cancer Epidemiology, Biomarkers and Prevention 14(5): 1157-1164) collated information relating to HPV type distribution amongst low-grade squamous intraepithelial lesions (LSIL) and compared it with the prevalence of HPV types in cervical cancers. The most common HPV type found was HPV 16 in all geographical regions studied. As with the other studies mentioned above, a marked variation in the next most prevalent HPV type on a region-by-region basis. In South/Central America, the next most prevalent HPV types were 33 and 6, whereas in North America they were found to be HPV types 51 and 56. In Asia, the next most prevalent types were 18 and 58, in Africa, types 53 and 58 were the next most prevalent and in Europe the next most prevalent types were 31 and 51.

Recently, Clifford et al. (Clifford G M, et al., (2005) The Lancet 366: 991-998) conducted a pooled analysis of HPV prevalence worldwide. The study showed a marked difference in the prevalence of HPV risk types across 11 countries. Whilst HPV type 16 remains the most common HPV type found in HPV positive women across all the countries in which samples we tested, variation in the prevalence of other high-risk HPV types such as types 18, 45, 31, 33, 52, 58 and so on was observed. In the case of populations in Europe, the high-risk HPV types most commonly found in HPV positive women were (in order of decreasing contribution) 16, 31 and 18 , with types 58, 56, 45 and 35 found in an equal number of HPV positive women in this region. By contrast, the population studied in Sub-Saharan Africa was found to have an equal prevalence of HPV types 16 and 35 in HPV positive women, and HPV types 45, 52, 56, and 58 were all more common than in Europe. In Asian populations a more heterogeneous distribution of HPV types was observed.

### SUMMARY OF THE INVENTION

The geographical differences in prevalence of high risk cancer-associated HPV types presents a problem for the design of an HPV-based diagnostic tool suitable for worldwide use. One solution could be to design a test which detects all known “high risk” HPV types. However, clinical studies by the present inventors and others have shown that whilst increasing the number of HPV types detected can improve the sensitivity of tests based on detection of HPV DNA and/or mRNA as a marker of cervical precancer (or as a risk factor for cervical cancer), the overall specificity of the test may be reduced.

The present inventors have addressed this problem by developing a method and apparatus which allows the user to filter a set of patient HPV measurement data according to the patient's geographical location, and output and/or display a subset of the HPV measurement data relating to a subset of HPV types which are appropriate for the geographical region in which the patient is located.

Therefore, in a first aspect of the invention there is provided a method of automatically providing an indication of the presence of selected ones of a plurality of HPV types in a cell sample provided by a human female. This method may comprise storing region HPV subset data defining a subset of said HPV types for each of a plurality of geographical regions, receiving a region identifier indicative of at least one of said geographical regions, receiving a plurality of measurements of HPV types and selecting the subset of said measurements defined by the region HPV subset data for the at least one geographical region indicated by the region identifier.

The method may further comprise the step of outputting or displaying only the HPV measurement data of the selected subset of measured HPV types.

In one embodiment the method of the invention may include the step of generating a set of HPV measurement data (i.e. a plurality of indications of measured HPV types) from a cell sample taken from a human female subject.

Preferably, the plurality of indications of measured HPV types includes indications of the measurement of at least 6 HPV types selected from the group consisting of 6, 53, 5, 8, 16, 18, 45, 31, 33, 52, 58, 35, 59, 56, 39, 51, 66, 68, 73, 82 and 70. In certain embodiments the plurality of indications of measured HPV types includes measurements for all of the HPV types listed in the previous sentence.

In a particular embodiment, the subset of HPV types defined in the region HPV subset data may comprise 3 or more HPV types.

In a second aspect of the invention, there is provided an apparatus for automatically providing an indication of selected ones of a plurality of HPV types detected in a cell sample provided by a human female, comprising region HPV data defining subsets of said plurality of HPV types for each of a plurality of geographical regions, a region identifier adapted to store a value indicative of a plurality of geographical regions and a processor adapted to direct to an output only the indications of the subset of detected HPV types defined by the region HPV subset data according to the value stored by the region identifier.

In a particular embodiment, the apparatus may be adapted to receive a cell sample provided by a human female and to provide to the processor indications of measured HPV types.

The processor may either control the apparatus adapted to provide to the processor indications of measured HPV types so that only certain indications are provided to the processor, or the processor may receive all indications of measured HPV types and discard those that do not correspond to the subset of detected HPV types defined by the region HPV subset data according to the value stored by the region identifier.

### DETAILED DESCRIPTION OF THE INVENTION

The method of the invention allows the user to test a cell sample from a human female subject for the presence of a broad set of individual HPV types and then filter the results such that only the results for a subset of the HPV types tested are actually outputted or displayed. The subset of results which are outputted or displayed is selected according to the geographical region in which the subject under test is located. It is therefore possible to design an assay system which is truly suitable for worldwide HPV testing. The broad set of HPV types for which all subjects are tested (irrespective of geographical location can be sufficiently broad to cover substantialiy all know “high risk” HPV types. All subjects are tested for all HPV types within this broad set, but the results are filtered such that only the results for a selected subset of the tested HPV types are actually reported.

Thus, instead of designing a separate assay kit or system for each geographical region or area, based on an appropriate set of HPV types, one can prepare a single assay kit or system for worldwide use, in which all test subjects are tested for all HPV types. Instead of reporting results of all tested HPV types for all subjects irrespective of location, which may result in a loss of specificity, one can selectively report only the subset of results deemed relevant for the geographical location of the test subject. Specificity of the test will be improved, relative to a test in which results for all high risk HPV types are reported for each test subject irrespective of geographical location.

### Indications of Measured HPV Types

The method of the invention relies on inputted data regarding “pluralities of indications of measured HPV types”. The “indications of measured HPV types” can be measurements of any molecular marker for the presence of HPV. This definition includes, for example, measurement/detection of HPV genomic DNA and also measurement/detection of a suitable HPV mRNA marker. Preferred methods may be based detection/measurement of HPV mRNA expression, particularly expression of E6/E7 mRNA transcripts, as the indicator of HPV type. The indications of measured HPV types must of course be HPV type-specific. Therefore, tests based on detection of HPV genomic DNA and/or HPV mRNA, particularly E6/E7 mRNA, must allow discrimination of which individual HPV types are present in the cell sample from the test subject. This HPV type-specific input data is necessary to allow one to filter the results based on the pre-determined selections of HPV types appropriate for particular geographical locations. The “cell sample” from the test subject may be any sample containing cell types which may be expected to harbor HPV infection. Suitable samples include test samples comprising cervical cells, e.g. cervical smears, scrapes, biopsies and liquid-based cytology samples.

In particular embodiments, the method of the invention may include the step of generating the input data, i.e. the plurality of indications of measured HPV types, starting from a cell sample from the subject under test. This step could include, for example, HPV typing based on detection of HPV genomic DNA for each of the broad set of “input” HPV types, or could be based on detection of an HPV mRNA marker for each of the broad set of “input” HPV types. In preferred embodiments the measurement of HPV types may be achieved by the detection of the presence or absence of HPV E6/E7 mRNA transcripts for the broad input set of HPV types. Measurement/detection of E6/E7 mRNA transcripts for each of the selected set of “input” HPV types can be achieved using any suitable molecular technique. Various methodologies for type-specific detection of HPV E6/E7 mRNA have been described in the art. In preferred embodiments E6/E7 mRNA may be detected using an amplification technique, such as for example NASBA, TMA, RT-PCR, etc. Suitable primers and probes for type-specific amplification and detection of mRNA transcripts (particularly E6/E7 mRNA transcripts) for a broad range of individual HPV types can be designed according to standard principles of primer and probe design, as would be well known to one of ordinary skill in the art. A number of sets of type-specific primers and probes suitable for detection of E6/E7 mRNA are described in the applicant's own publication WO03/057927 the contents of which are incorporated herein by reference.

### Selection of Input HPV Types

The “input” set of HPV types can be as broad as is desired or necessary to provide “worldwide” coverage. For example, one could include substantially all known “high risk” or cancer-associated HPV types. The format of the method allows one to include obscure or rare HPV types, including types which are relevant only to one particular geographical location, without adversely affecting overall specificity of the test, since one will only output or display results which are deemed relevant for the geographical location of the particular test subject being investigated.

In particular non-limiting embodiments the “input” HPV types may be selected from the following list: 6, 53, 5, 8, 16, 18, 45, 31, 33, 52, 58, 35, 59, 56, 39, 51, 66, 68, 73, 82 and 70. Specific embodiments may be based on input data for at least 6, at least 10, at least 14 or all of the HPV types on this list. Further “high risk” HPV types may be included if desired.

### Selection of HPV Subsets by Region

A characterising feature of the method of the invention is that typing data is generated/inputted for all the chosen input HPV types (irrespective of the geographical location of the test subject), but only a subset of the data for a selected subset of HPV types is outputted or displayed, this subset being selected according to the geographical region in which the test subject is located. The output subset of HPV types is pre-determined for each geographical region of interest. The total number of HPV types included in each region-specific output subset will be less than the total number of HPV types in the broad input set of HPV types. However, the precise number of HPV types, and the identity of these types, will vary for each geographical region. The number of HPV types in each region-specific output set will typically be at least 3, and the total number of types in any given subset may be 3, 4, 5, 6, 7, 8, or 9 types.

Suitable output sets of HPV types for particular geographical regions may be designed based on HPV prevalence data for the geographical region in question, or may be determined based on the results of clinical studies. By way of non-limiting example, an output subset for subjects located in Europe may include (or consist of) HPV types 16, 18, 31, 33 and 45. An output subset for Asia may include (or consist of) HPV types 16, 18 and 52. An output subset for North Africa, Sub-Saharan Africa or Asia may include (or consist of) HPV types 16, 18, 31 and 33. Output subsets for USA/North Americe may include (or consist of) HV types 16, 31 or 33; or types 16, 18 and 35; or types 16, 18 and 58, or types 16, 33 and 58.

### Apparatus of the Invention

The apparatus of the invention may be configured to work with input data on “indications of measured HPV types” determined remotely. Alternatively, the apparatus of the invention, or a system incorporating the apparatus of the invention as a component, may itself include components designed to generate measurements for the input HPV types.

Accordingly, the invention contemplates an apparatus or system which includes means for detecting/measuring molecular markers of HPV type, such as for example HPV genomic DNA and/or HPV mRNA, for a pre-determined set of input HPV types, in addition to the means for processing the HPV typing results and outputting only those results for the subset of measured HPV types defined by the region HPV subset data according to the value stored by the region identifier. Particular embodiments of this apparatus/system may include means for type-specific detection of E6/E7 mRNA expression for the input set of HPV types.

The means for detecting/measuring molecular markers of HPV type may take any suitable form. For example, means for detection of HPV DNA or HPV E6/E7 mRNA may include nucleic acid amplification assays performed in standard PCR reaction tubes, or in a microtiter plate format, or even a microarray format. A particularly convenient format may be based on a microfluidic reaction chamber system which enables separate reactions for individual HPV types to performed on separate aliquots of the same patient sample in parallel. Suitable systems include that described in the applicant's own publication WO02/22265, incorporated herein by reference. It is also contemplated to use microfabricated/microfluidic systems which perform integrated sample processing, such as those described in the applicant's own publications, WO 2005/073691 and WO 2008/149111, incorporated herein by reference.

1. A method of automatically providing an indication of the presence of selected ones of a plurality of HPV types in a cell sample provided by a human female, comprising:
storing region HPV subset data defining a subset of said HPV types for each of a plurality of geographical regions;
receiving a region identifier indicative of at least one of said geographical regions;
receiving a plurality of measurements of HPV types; and
selecting the subset of said measurements defined by the HPV subset data for the at least one geographical region indicated by the region identifier.

2. The method of claim 1, further comprising the step of outputting or displaying only the presence of the selected subset of HPV types.

3. The method of claim 1, wherein the plurality of measurements of HPV types includes measurements of at least 6 of HPV types 6, 53, 5, 8, 16, 18, 45, 31, 33, 52, 58, 35, 59, 56, 39, 51, 66, 68, 73, 82 and 70.

4. The method of claim 1, wherein the subset of HPV types defined in the region HPV subset data comprises 3 or more HPV types.

5. The method of claim 1, which comprises the additional step of generating a plurality of measurements of HPV types.

6. Apparatus for automatically providing an indication of selected ones of a plurality of HPV types in a cell sample provided by a human female comprising:
region HPV data defining subsets of said plurality of HPV types for each of a plurality of geographical regions;
a region identifier adapted to store a value indicative of a plurality of geographical regions; and
a processor adapted to direct to an output only the indications of the subset of measured HPV types defined by the region HPV subset data according to the value stored by the region identifier.

7. The apparatus of claim 6, further comprising an apparatus adapted to receive a cell sample provided by a human female and to provide to the processor indications of detected HPV types.

8. The apparatus of claim 7, wherein the processor controls the apparatus adapted to provide to the processor indications of detected HPV types so that only certain indications are provided to the processor.

9. The apparatus of claim 8, wherein the processor receives all indications of measured HPV types and discards those that do not correspond to the subset of measured HPV types defined by the region HPV subset data according to the value stored by the region identifier.
